(19) United States
(12) Patent Application Publication
(10) Pub. No.: US 2008/0121577 A1
(43) Pub. Date: May 29, 2008

(54) Filter for composite water treatment and sewage treatment

(75) Inventor: Talloen Marc, Turnhout (BE)

Correspondence Address: BRUCE H. TROXELL;SUITE 1404, 5205 LEESBURG PIKE, FALLS CHURCH, VA, 22041, US

(73) Assignees: UNION COOPER CO., LTD.; BHB Asia Technology Co., Ltd.

(21) Appl. No.: 11/605,394

(22) Filed: Nov. 29, 2006

(51) Int. Cl. C02F 3/00; B01D 39/04

(52) U.S. Cl. 210/151; 210/150; 210/489; 210/508; 210/615

(57) ABSTRACT

A filter for composite water treatment and sewage treatment includes at least two filters for sewage to pass through respectively. Each of the filters is composed of numerous ringed filaments twisted and entangled together irregularly. And, among the ringed filaments, there are also numerous interspaces formed to let sewage flow through. Each filter has a coarser diameter for its ringed filaments and a larger space for its interspaces than that positioned behind it does.

### BACKGROUND OF THE INVENTION

1. Field of the Invention

This invention relates to a kind of filter, particularly to one that is installed in equipment of sewage treatment and a microbe filtrating tank.

2. Description of the Prior Art

Commonly, a conventional filter is applied to various sewage treatments such as:

1. Sewage treatment of houses, aquiculture and garden;

2. Sewage treatment of buildings;

3. Treatment for waters of dug ponds, rivers, lakes and others; and

4. Treatment for waters rainstorms.

The methods of the water treatment usually include adsorption, sedimentation and microbe decomposition, even purification, disinfection and reduction of water contamination as well.

### SUMMARY OF THE INVENTION

The prime object of this invention is to offer a filter for composite water treatment and sewage treatment.

The main characteristic of the invention is a block formed as a preset shape (plate, column or cylinder). Each block has a different density and surface filtrating feature. The various blocks can be piled up in different ways to meet various sewage treatments, achieving an optimal sewage filtration to keep effluent water conforming to the criterion. The blocks classified into three varieties are respectively composed of numerous ringed filaments formed by thermal extrusion and twisted together irregularly. There are also numerous interspaces formed among blocks for sewage to pass through. The density and surface filtrating feature of the block are characterized by the diameter of the ringed filament and the size of the interspaces. In using, the sewage flows first through the sparse block and then, gradually through the denser blocks, able to enhance filtrating effect and microbe decomposition. In addition, the combination of the blocks can be installed inside a vacuum tube so as to keep it convenient for loading, unloading and cutting.

### BRIEF DESCRIPTION OF DRAWINGS

This invention is better understood by referring to the accompanying drawings, wherein:

FIG. 1 is a perspective view of a preferred embodiment of a filter for composite water treatment and sewage treatment in the present invention;

FIG. 2 is a partial magnified view of a ringed filament of a block in the filter in the present invention;

FIG. 3 is a cross-sectional view of a first application of the filter in the present invention for a biological filtrating system;

FIG. 4 is an illustration of a second application of the filter in the present invention for a biological filtrating tank;

FIG. 5 is a vertical cross-sectional view of a third application of the filter in the present invention for a biological filtrating system;

FIG. 6 is a horizontal cross-sectional view of the third application of the filter in the present invention for a biological filtrating system;

FIG. 7 is a vertical cross-sectional view of a fourth application of the filter in the present invention for a biological filtrating system; and

FIG. 8 is a horizontal cross-sectional view of the fourth application of the filter in the present invention for a biological filtrating system.

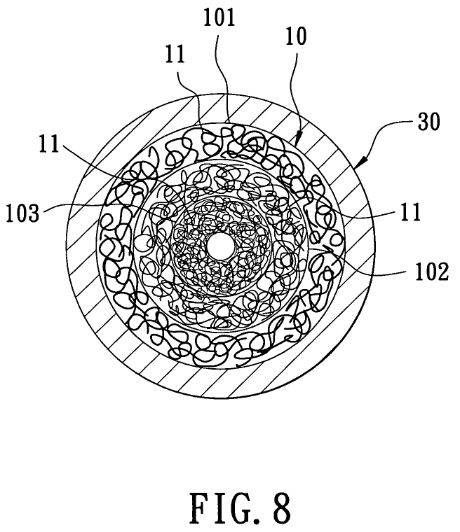

### DETAILED DESCRIPTION OF THE PREFERRED EMBODIMENT

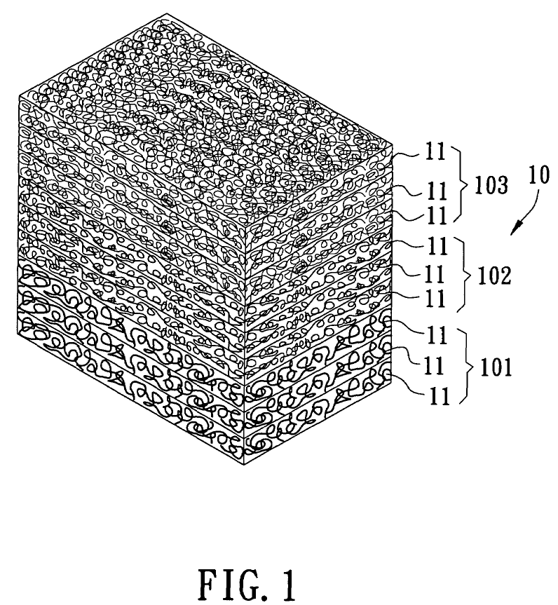

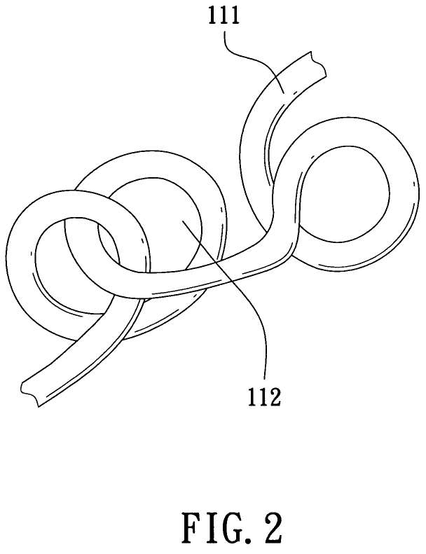

FIGS. 1 and 2 show a preferred embodiment of a filter 10 for composite water treatment and sewage treatment in the present invention. The filter 10 consists of a first filter 101, a second filter 102 and a third filter 103, serving to be passed through successively by sewage. Each of the first, the second and the third filters 101, 102, 103 is composed of plural blocks 11 formed in a certain shape, such as a long and thin one in this embodiment. The block 11 is made of thermoplastic high molecular polymer, manufactured via thermal extrusion to form numerous irregular ringed filaments 111 that are mutually twisted and entangled together and piled up. And, among the ringed filaments 111, there are also numerous interspaces 112 formed to let sewage flow through. The diameter of the ringed filament 111 of the first filter 101 is coarser than that of the second filter 102, and that of the second filter 102 is coarser than that of the third filter 103. In addition, the interspaces of the ringed filament 111 of the first filter 101 are larger than those of the second filter 102, and those of the second filter 102 are larger than those of the third filter 103. In other words, the block 11 of the filter 10 has thinner ringed filaments 111 and smaller interspaces 112 than that positioned previously does.

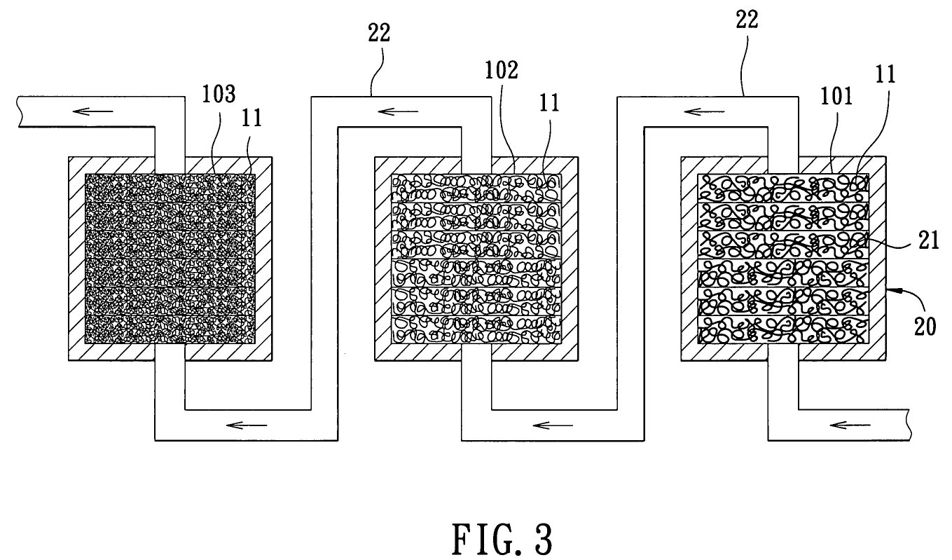

FIG. 3 shows a first installation embodiment of the present invention. The first, the second and the third filter 101, 102, 103 are respectively installed in an accommodating chamber 21 of different microbe or mechanical reactors 20. The blocks 11 of each filter 10 are piled up along sewage flowing direction. There is a linking tube 22 connected between every two adjacent reactors 20. In using, the sewage to be treated is transferred into the reactor 20 of the first filter 101 through the linking tube 22 and filtrated primarily by the ringed filaments 111 and the interspaces 112 of the blocks 11 to carry out decomposition at the same time, and next, transferred subsequently into the reactor 20 of the second filter 102 via the linking tube 22 and filtrated further by the ringed filaments 111 and the interspaces 112 of the blocks 11 to undertake decomposition, and finally, transferred into the reactor 20 of the third filter 103 via the linking tube 22 and filtrated further by the ringed filaments 111 and the interspaces 112 of the blocks 11 to undertake decomposition. The treated sewage running out of the third filter 103 is sent to a treating tank for a follow-up treatment, achieving a significant staged filtration and microbe decomposition.

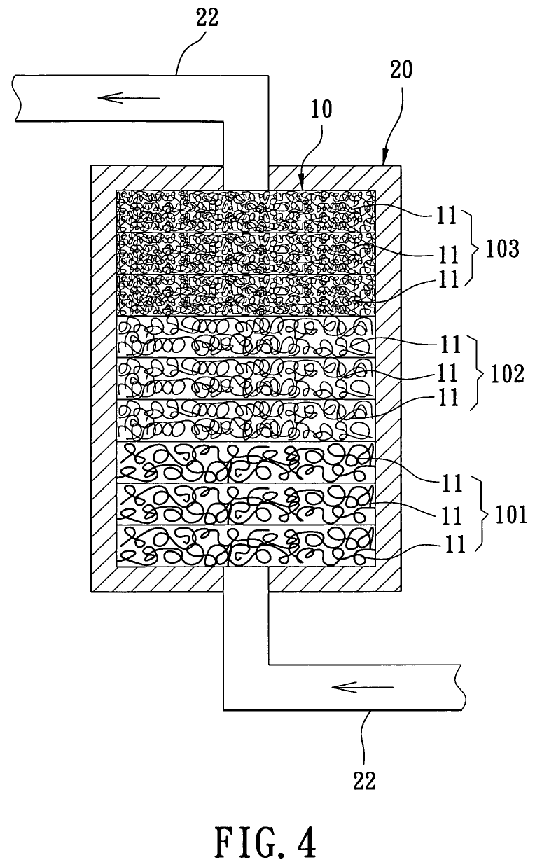

FIG. 4 shows a second installation embodiment of the present invention. The first, the second and the third filter 101, 102, 103 are installed in an accommodating chamber 21 of a microbe reactor 20. The blocks 11 of each filter 10 are piled up orderly along the sewage flowing direction. In using, the sewage is transferred to flow through the blocks 11 of the first, the second and the third filters 101, 102 and 103 in order, achieving a significant staged filtration and microbe decomposition.

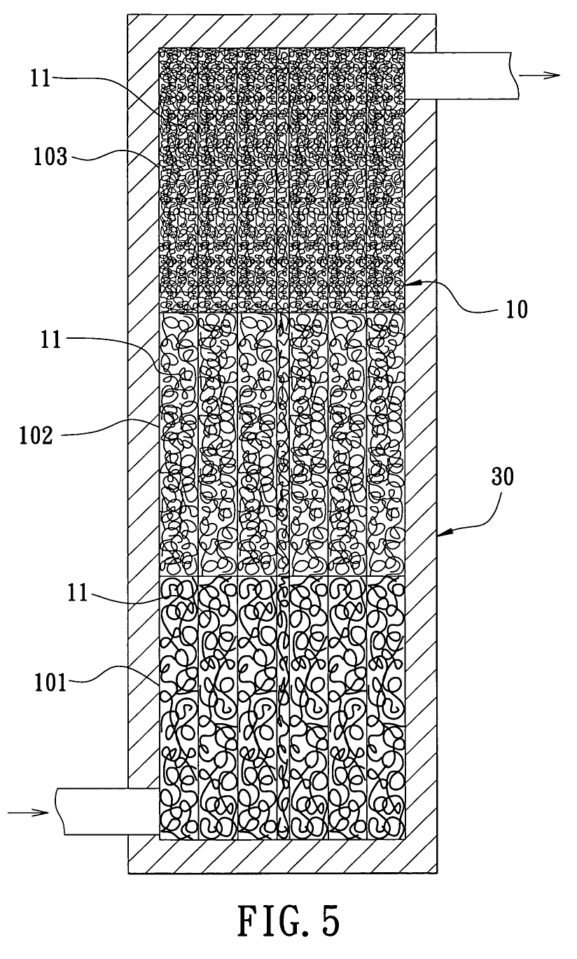

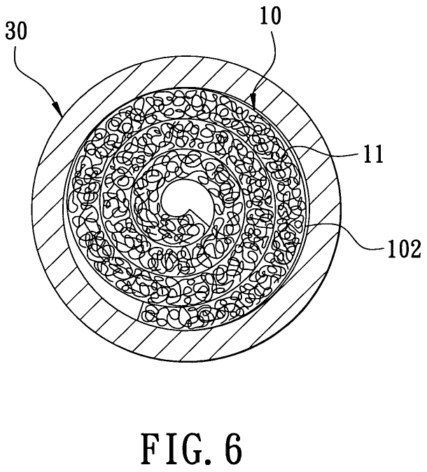

FIGS. 5 and 6, respectively a cross-sectional view, show a third installation embodiment of the present invention. The filter 10 is installed in a filtrating column 30 of an aquarium or a fishpond or an aqua farm. The block 10 of each of the first, the second and the third filter 101, 102 and 103 is rolled to form as a column and installed in the filtrating column 30 co-axially to make the filters 101, 102 and 103 packed from the bottom to the top in order, achieving a significant staged filtration and microbe decomposition as well.

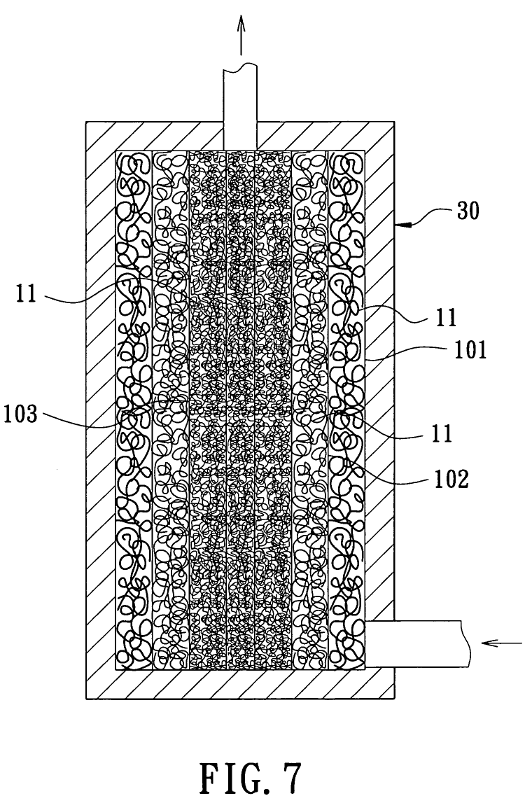

FIGS. 6 and 7, respectively a cross-sectional view, show a fourth installation embodiment of the present invention. The block 10 of each of the first, the second and the third filter 101, 102 and 103 is rolled to form as a cylinder having a different diameter and installed in the filtrating column 30 co-axially to make the filters 101, 102 and 103 wrapped together from the outside to the inside in order, achieving a significant staged filtration and microbe decomposition as well.

It should be noted that the irregular ringed filaments 111 and interspaces 112 can make the sewage run in disorder so as to obtain a homogeneous effect. In addition, with the different sizes of the ringed filaments 111 and the interspaces 112 designed among the first, the second and the third filters 101, 102 and 103, it can not only prevent the interspaces 112 from clogged, but also undertake staged filtration and microbe decomposition. With a further description, the first filter 101 can only block big-size substances and most of the mud and impurities in the sewage owing to its bigger ringed filament 111 and interspaces 112, keeping filtration more dominant than microbe decomposition in the first filter 101. As the ringed filament 111 and interspaces 112 become gradually smaller for the second and the third filter 102 and 103, the mud and the impurities blocked are of course to be reduced and the microbes attaching on the ringed filaments 112 for decomposing organic compounds in the sewage are increased, so that microbe decomposition becomes gradually more dominant than filtration does in the second and the third filter 102 and 103. Therefore, an optimal filtration and microbe decomposition for sewage treatment is achieved to meet the standard of effluent water.

While the preferred embodiment of the invention has been described above, it will be recognized and understood that various modifications may be made therein and the appended claims are intended to cover all such modifications that may fall within the spirit and scope of the invention.

What is claimed is:

1. A filter for composite water treatment and sewage treatment, said filter comprising plural filters made of thermoplastic high molecular polymer and manufactured via thermal extrusion to form numerous irregular ringed filaments that are mutually twisted and entangled together and then piled up, numerous interspaces formed between said ringed filaments to let sewage flow through, each said filter having a coarser diameter for its ringed filaments and a larger sp ace for its interspaces than that positioned behind it does.

2. A filter for composite water treatment an d sewage treatment as claimed in claim 1, wherein said filters are formed as blocks.

3. A filter for composite water treatment and sewage treatment as claimed in claim 1, wherein said filters include at least three different specifications for said ringed filaments and said interspaces.

4. A filter for composite water treatment and sewage treatment as claimed in claim 1, wherein said filters are installed in a same accommodating chamber.

5. A filter for composite water treatment and sewage treatment as claimed in claim 3, wherein said filters are piled up orderly along a sewage flowing direction.

6. A filter for composite water treatment and sewage treatment as claimed in claim 1, wherein said filters are installed in different accommodating chambers.

7. A filter for composite water treatment and sewage treatment as claimed in claim 1, wherein each of said filters is rolled to form as a column and installed in order in a filtrating column co-axially.

8. A filter for composite water treatment and sewage treatment as claimed in claim 1, wherein each of said filters is rolled to form as a cylinder having a different diameter and wrapped together to install in a filtrating column.
